(19) United States
(12) Patent Application Publication
(10) Pub. No.: US 2018/0258512 A1
(43) Pub. Date: Sep. 13, 2018

(54) TITANIUM-TANTALUM ALLOY AND METHOD OF FORMING THEREOF

(71) Applicants: NANYANG TECHNOLOGICAL UNIVERSITY, Singapore (SG); AGENCY FOR SCIENCE, TECHNOLOGY AND RESEARCH, Singapore (SG)

(72) Inventors: Swee Leong SING, Singapore (SG); Wai Yee YEONG, Singapore (SG); Florencia Edith WIRIA, Singapore (SG)

(21) Appl. No.: 15/761,078

(22) PCT Filed: Sep. 19, 2016
(86) PCT No.: PCT/SG2016/050455

§ 371 Date: Mar. 16, 2018

(30) Foreign Application Priority Data
Sep. 17, 2015 (SG) 10201507752T

(51) Int. Cl. C22C 14/00; B22F 3/105; B22F 1/00

(52) U.S. Cl. CPC C22C 14/00; B22F 3/1055; B22F 1/0011; B22F 2201/10; B22F 2301/205; B22F 2201/20; B22F 2999/00

(57) ABSTRACT

A titanium-tantalum alloy having a titanium wt % ranging from 10% to 70% and wherein the titanium has a body centered cubic structure. A method of forming a titanium-tantalum alloy, the method comprising the steps of: (a) slicing a 3D CAD model of a part to be formed into a plurality of 2D image layers; (b) preparing a homogenous powder mixture of titanium powder and tantalum powder; (c) dispensing a layer of the powder mixture onto a processing bed; (d) performing powder bed fusion of the layer of the powder mixture according to one of the 2D image layers in one of: a vacuum environment and an inert gas environment; and performing steps (c) and (d) for each of the plurality of 2D image layers in succession.

### FIELD

This invention relates to a titanium-tantalum alloy and a method of forming thereof.

### BACKGROUND

Titanium and titanium alloys are among the most attractive implant materials, due to their light weight, high bio corrosion resistance, biocompatibility and mechanical properties. For example, commercially pure titanium and Ti-6Al-4V are two of the most widely implant materials used next to cobalt-chromium and stainless steel. However, their relative poor mechanical properties, including mismatch of their elastic modulus compared to the elastic modulus of bone, limit the extent of their use. Additionally, Ti6Al4V has been reported to release aluminium and vanadium ions from the alloy that might cause some long term health problems.

With implants being placed in younger people and remaining in the body for longer periods of time, there is a need for an implant material with better biocompatibility and does not to have a harmful effect on the body. Titanium-tantalum (TiTa) alloys have been suggested to be superior for use as biocompatible implant materials, because of their lower modulus and comparable strength. In addition, titanium-tantalum alloys save weight and cost compared to pure tantalum and are expected to present higher corrosion resistance. However, there remain limited detailed investigations into the development of titanium-tantalum alloys. Some efforts have been directed towards powder based additive manufacturing (AM) techniques to process titanium-tantalum alloys, such as selective laser melting (SLM), electron beam melting (EBM) and laser engineered net shaping (LENS). The conventional processes used to produce alloys by these methods require use a feedstock of pre-alloyed materials. However, this is not economically possible for titanium and tantalum due to the difficulties in combining these two elements together as they have great difference in melting point and density. In particular, tantalum has a density of 16.6 g/cm³ which is about four times of the density of commercially pure titanium (4.51 g/cm³).

Other methods previously used for creating titanium-tantalum alloys include arc melting, plasma torch melting and cold crucible levitation melting. However, these methods require multiple steps to achieve the alloy and lack the ability to form functional parts directly. The functional parts have to be formed separately using additional processes such as hot rolling or casting, leading to increase in manufacturing costs and time.

There is therefore still no effective mechanism for forming titanium-tantalum alloy parts directly.

### SUMMARY

The present application discloses a titanium-tantalum alloy and a process for forming titanium-tantalum alloys. Homogeneous titanium-tantalum alloy may be obtained using a powder bed fusion process such as selective laser melting (SLM). The resulting alloy has comparable mechanical strength to Ti6Al4V, while titanium-tantalum alloy is more suitable for biomedical applications due to its lower Young's modulus. In addition, the Young's modulus of the titanium-tantalum alloy obtained by SLM is lower compared to the same alloy obtained by other methods. The lower Young's modulus minimises an adverse effect called “stress shielding” due to mismatch in modulus between a metal implant and natural bone. The mechanical strength of the titanium-tantalum alloy is also much higher.

The process includes preparing a suitable powder mixture of commercially pure titanium (cpTi) powder and pure tantalum powder, and performing powder bed fusion of the powder mixture, e.g. by selective laser melting, in a vacuum or inert gas environment to form titanium-tantalum parts directly.

Key advantages include:

1. Single step formation of functional parts—Due to the net shape forming capability of 3D printing, titanium-tantalum parts can be fabricated directly.

2. Cost saving—As this is an additive manufacturing process, cost saving can be achieved by reduction in material wastage

3. Customisation—Production can be customised specifically as compared to other methods listed above. This is especially advantageous for biomedical industry where customised implants can be fabricated to suit specific patients.

4. Mechanical properties obtained are superior compared to other methods and more suitable for biomedical applications

According to a first aspect, there is provided a titanium-tantalum alloy having a titanium wt % ranging from 10% to 70% and wherein the titanium has a body centered cubic structure.

The titanium-tantalum alloy may have a Young's modulus of less than 80 GPa and ultimate tensile strength greater than 900 MPa.

The titanium-tantalum alloy may be homogenous, having domains of titanium and tantalum each at most 1 mm long.

According to a second aspect, there is provided a method of forming a titanium-tantalum alloy, the method comprising the steps of:
(a) slicing a 3D CAD model of a part to be formed into a plurality of 2D image layers;
(b) preparing a homogenous powder mixture of titanium powder and tantalum powder;
(c) dispensing a layer of the powder mixture onto a processing bed;
(d) performing powder bed fusion of the layer of the powder mixture according to one of the 2D image layers in one of: a vacuum environment and an inert gas environment; and
(e) performing steps (c) and (d) for each of the plurality of 2D image layers in succession.

Particle size of the titanium powder may range from 5 μm to 40 μm.

Average particle size of the tantalum powder may be at most 44 μm.

Performing powder bed fusion may comprise selective laser melting and the energy density during the selective laser melting ranges from 96 J/mm³ to at least 1400 J/mm³.

For both aspects, weight ratio of titanium to tantalum may be 1:1.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings.

FIG. 1 is a schematic illustration of a method of forming a titanium-tantalum alloy.

FIG. 2 is graphs showing mechanical properties of titanium-tantalum alloy at different weight ratios of titanium to tantalum.

FIG. 3a is an FESEM micrograph of a titanium-tantalum alloy produced by selective laser melting.

FIG. 3b is an FESEM micrograph of the titanium-tantalum alloy produced selective laser melting showing an unmelted tantalum powder particle.

FIG. 4 is a photograph of titanium-tantalum tensile coupons fabricated using selective laser melting.

FIG. 5 is a photograph of porous titanium-tantalum alloy scaffolds fabricated using selective laser melting.

FIG. 6 is a photograph of sample implants fabricated using selective laser melting.

FIG. 7 is a graph illustrating relative cell numbers on commercially pure titanium, Ti6Al4V and TiTa porous structures.

FIG. 8 is a flowchart of a method of forming a titanium-tantalum alloy.

### DETAILED DESCRIPTION

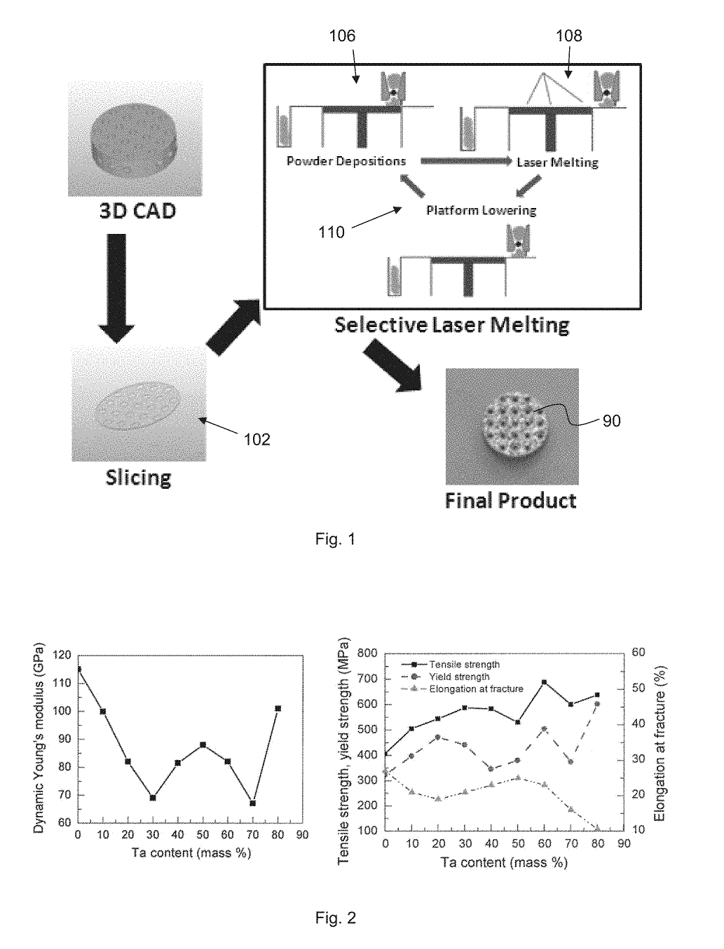

Exemplary embodiments of a titanium-tantalum alloy 90 and a method (100) of forming titanium-tantalum alloy will be described below with reference to FIGS. 1 to 8. The same reference numerals are used throughout the figures to denote the same or similar parts among the various embodiments.

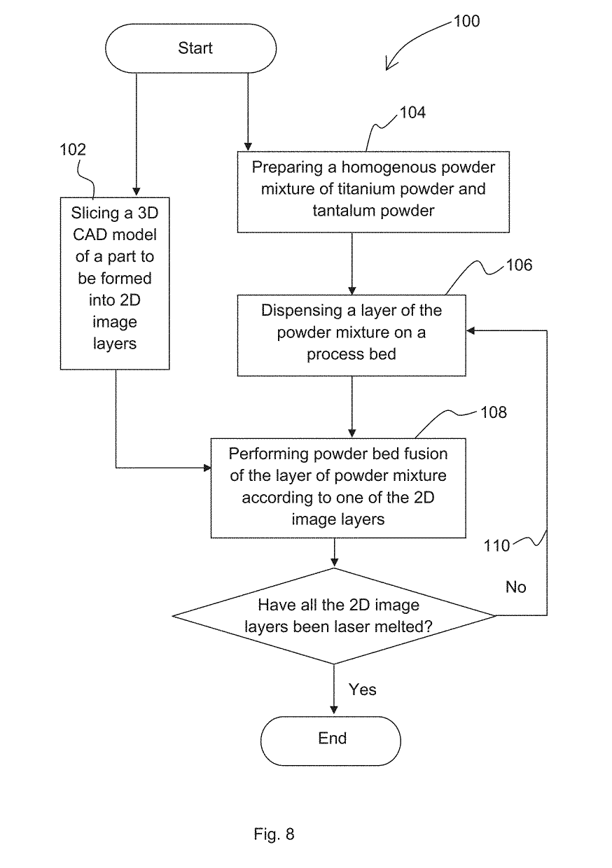

In an exemplary embodiment of a method (100) of forming titanium-tantalum alloy 90 as illustrated in FIGS. 1 and 8, first, titanium and tantalum powders were homogenously mixed (104). The term “powder” refers to discrete particles of titanium or tantalum. Preferably, commercially pure titanium powder was used that was plasma atomized and spherical in shape with a particle size of from 5 to 40 μm. Pure tantalum powder was used that had particles that are irregular in shape and had an average particle size of 44 μm. The particle size of the powders used was chosen to take into account limiting factors of the selective laser melting (SLM) process and also thickness of the powder layer deposition to be used during SLM, which in the exemplary embodiment was 50 μm.

The large difference in the density of the titanium powder (4.51 g/cm3) and the tantalum powder (16.6 g/cm3) requires careful mixing processes to be used in order to obtain homogeneity and prevent the tantalum which is about four times the density of the titanium from segregating to the bottom of the powder mixture. By homogenous, it means that the alloy includes no domains of either titanium or tantalum larger than 1 mm. Homogeneity allows the mechanical properties to be constant throughout the whole materials/parts formed. To ensure that the powder mixture is homogeneous, random samples are checked using inductively coupled plasma mass spectrometry (ICP-MS) or similar detection methods.

In one embodiment, the two powders were mixed in a 1:1 percentage weight to weight ratio and then spun at a rate of 60 rpm for about 12 hours using a tumbler mixture to obtain a homogenous mixture (104). The weight ratio of the two powders may be varied to fine tune properties of the titanium-tantalum alloy 90. The effect of altering the weight percentage ratio of titanium to tantalum, is known from previous studies of titanium-tantalum alloy 90s produced by an arc melting process 121, as shown in FIG. 2.

The homogenously mixed (104) powder mixture is then loaded into the dispensing mechanism of a selective laser melting machine which will dispense a first layer of the powder mixture onto the process bed (106). The selective laser melting process begins with the slicing of a 3D CAD model of a component or part to be formed into a plurality of layers of 2D images (102). Each of the plurality of 2D image layers is built on top of each other by to create the 3D part. In the presently disclosed process (100), selective laser melting (108) according to each of the 2D image layers is carried out on the homogenous powder mixture (104) dispensed on the process bed (106). Dispensing a layer of powder (106) and selective laser melting (108) the dispensed powder mixture layer is repeated layer by layer for each of the layers of 2D images (110) to obtain the titanium-tantalum alloy 90 part. Fusion between the layers is achieved by a laser source, layer by layer, until the part 90 is fully formed. The metal powder mixture is melted, not just sintered, resulting in parts that are fully dense. A schematic of the process is shown in FIG. 2.

Due to the large differences in the melting points of titanium (1650° C.) and tantalum (3020° C.), careful melting of the metal powders is required to obtain a homogeneous product. Selective laser melting (108) is performed using a laser with a power of 360 W, and a scanning speed of from 200 to 600 mm/s with a hatch spacing of from 0.025 to 0.125 mm. As a result, the range of energy density used was from 96 to 1400 J/mm³. An inert gas (e.g. argon) or vacuum environment prevents any interstitial elements pick up during the process, and a pressurized chamber during SLM (108) prevents any significant vapor loss of the titanium before the tantalum has melted. For example, operating pressure of up to 2 Bar may be used. In addition, rapid solidification of each layer during the SLM (108) process minimizes any segregation of the metals due to coring. Coring is the development of compositional segregation during slow cooling of a cast material. These parameters and conditions produced titanium-tantalum alloy 90 layers that were found to be fully dense.

The steps involved in an exemplary embodiment of the process 100 described above are summarized below:

1) Mixing commercially pure titanium (cpTi) and pure tantalum powder in the proportion of X % and (100-X) % to form a homogenous titanium and tantalum mixture (104).

2) Dispensing the homogenous powder mixture of titanium and tantalum on a process bed (106) enclosed in a chamber filled with inert gas (e.g. argon) or in a vacuum chamber.

3) Using a power source to melt the first layer of the titanium and tantalum mixture (108) corresponding to the first layer of the titanium-tantalum alloy part based on pre-designed computer aided design file (102). This is followed by rapid solidification of the first layer.

4) The power source then melts a subsequent layer of titanium-tantalum powder mixture that is dispensed on the process bed, corresponding to the subsequent layer of the part, followed by rapid solidification of this layer. (108)

5) Process step (4) is repeated (110) until the corresponding titanium-tantalum alloyed part is fabricated.

6) The power source uses an energy density of 96 J/mm³ to 1440 J/mm³. Energy density will vary depending on composition of the titanium-tantalum alloy to be fabricated.

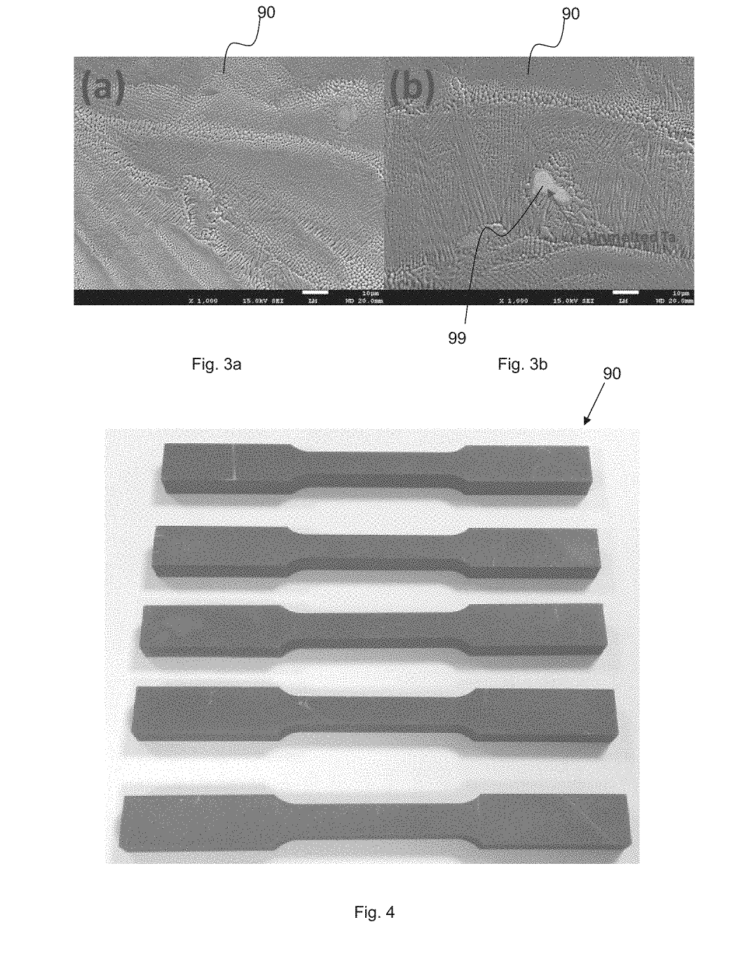

As shown in FIG. 3a, in one example, the titanium-tantalum alloys 90 produced by SLM have a titanium-tantalum solid solution matrix with unmelted tantalum particles. The composition of the titanium-tantalum matrix was determined to be 50.74±0.82 wt % titanium and 49.26±0.82 wt % tantalum where 1:1 percentage weight to weight ratio or 50% each of titanium and tantalum powder was used. The applied energy density used in the selective laser melting (108) process was sufficient to fully melt the titanium powder while some of the larger tantalum particles (99) only melted partially due to the higher melting point of tantalum, as can be seen in FIG. 3b. To avoid inclusion of unmelted tantalum in the alloy 90, a smaller particle size of tantalum powder can be used or energy density applied during the selective laser melting (108) process can be increased.

The properties of bulk TiTa 90 obtained via SLM and arc melting for the same composition are compared and tabulated in Table 1 below.

TABLE 1

| | | | Ultimate | | | |
|---|---|---|---|---|---|---|
| | | Young's | tensile | Yield | Elon- | |
| | Phase | modulus | strength | strength | gation | Refer- |
| Method | present | (GPa) | (MPa) | (MPa) | (%) | ence |
| SLM | β | 75.77 ± | 924.64 ± | 882.77 ± | 11.72 ± | This |
| | | 4.04 | 9.06 | 19.60 | 1.13 | work |
| Arc | α″ | 88 | 530 | 375 | 25 | [1, 2] |
| melting | | | | | | |

The titanium-tantalum alloy 90 obtained from the above described process (100) was characterised according to ASTM E8 (Standard Test Methods for Tension Testing of Metallic Materials). FIG. 4 shows the TiTa 90 coupons fabricated and used in the tensile tests. Results of the tensile tests of the bulk titanium-tantalum alloy 90 obtained by the selective laser melting process (100) are shown in Table 2 below in comparison with the tensile properties of Ti6Al4V and commercially pure titanium (cpTi).

TABLE 2

| | Young's | Ultimate tensile | Yield | Elonga- |
|---|---|---|---|---|
| Material | modulus (GPa) | strength (MPa) | strength (MPa) | tion (%) |
| Titanium- | 75.77 ± | 924.64 ± | 882.77 ± | 11.72 ± |
| tantalum | 4.04 | 9.06 | 19.60 | 1.13 |
| Ti6Al4V | 131.51 ± | 1165.69 ± | 1055.59 ± | 6.10 ± |
| | 16.40 | 107.25 | 63.63 | 2.57 |
| cpTi | 111.59 ± | 703.05 ± | 619.57 ± | 5.19 ± |
| | 2.65 | 16.22 | 20.25 | 0.32 |

As can be seen in Table 2, Young's modulus of SLM-produced titanium-tantalum 90 is the lowest, being less than 80 GPa, making it more suitable for biomedical applications by minimizing the adverse effect of stress shielding. In addition, the titanium-tantalum 90 specimens have ultimate tensile strength greater than 900 MPa, and higher ductility than Ti6Al4V, as shown by the higher elongation at yield. This means that the SLM-produced titanium-tantalum can be expected to be less brittle and therefore less prone to sudden failure, and have greater fatigue strength, than Ti6Al4V.

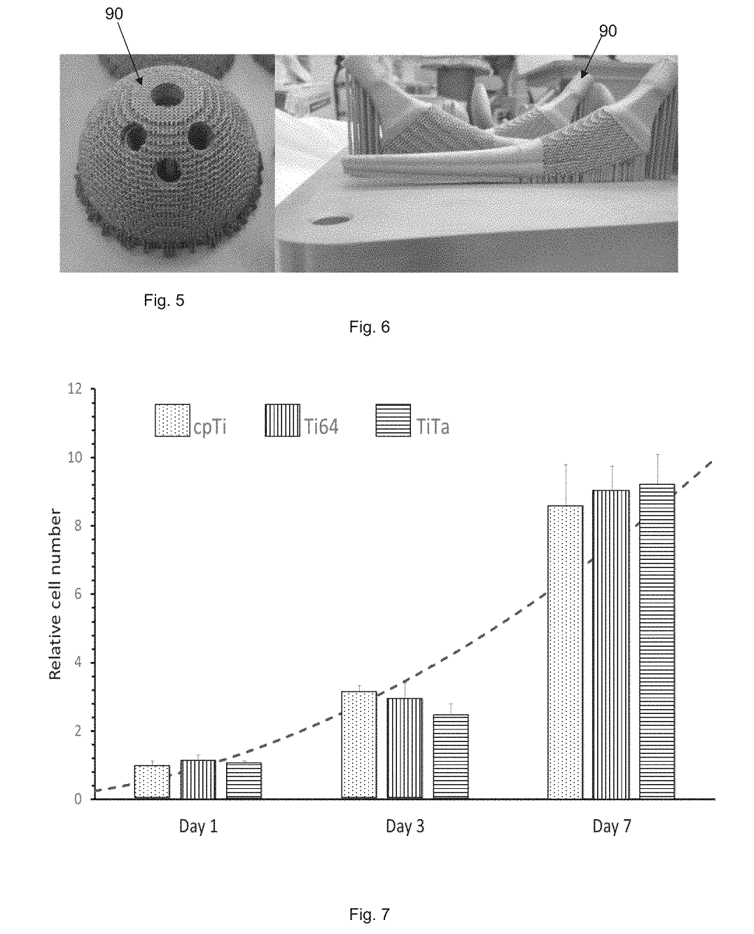

Porous titanium-tantalum 90 structures with 60% porosity were also fabricated using SLM (100). Examples of the fabricated porous structures 90 are shown in FIGS. 5 and 6. As can be seen, the porous structures 90 fabricated may be a portion of the part or the entire part may be porous. The porous structures may have a porosity of from 0% to 80%. Here, porosity is a ratio of volume of pores to the total volume of the porous structure.

The porous structures 90 were characterized according to international standard ISO 13314-2011 (Mechanical testing of metals—Ductility testing—Compression test for porous and cellular metals). The resulting elastic constant in compression and yield strength of the as-fabricated porous structures are shown in Table 3 below in comparison with Ti6Al4V and commercially pure titanium.

TABLE 3

| Material | Elastic constant (GPa) | Yield strength (MPa) |
|---|---|---|
| Titanium-tantalum | 4.57 ± 0.09 | 151.93 ± 8.47 |
| Ti6Al4V | 5.47 ± 0.73 | 181.14 ± 15.05 |
| cpTi | 4.29 ± 0.15 | 121.20 ± 3.67 |

As can be seen in Table 3, the elastic constant of SLM (100) produced TiTa 90 lattice structures is lower compared to Ti6Al4V and is comparable to commercially pure titanium. The slightly higher TiTa elastic constant can be attributed to the presence of unmelted tantalum in the materials, resulting in resistance to the dislocation of the grains during compression. Nonetheless, TiTa 90 still has the advantage of higher modulus to strength ratio as compared to commercially pure titanium in compression. In addition, TiTa 90 also exhibits lower Young's modulus and higher strength compared to commercially pure titanium under tension. These make TiTa 90 a more suitable material for use as porous and load bearing structures for biomedical applications where implants undergo both compression and tension.

The porous TiTa 90 structures formed by the above described process (100) were also biocompatibility tested using human osteosarcoma cell lines SAOS-2. The cell viability was assessed using dsDNA picogreen assay and the results as compared to Ti6Al4V and commercially pure titanium are shown in FIG. 7.

As can be seen in FIG. 7, after 7 days of n vitro culture, the SAOS-2 cells were found to be viable and proliferating on all the porous structures 90. On days 1, 3, and 7, the relative cell number on the scaffolds of the three materials were similar. This shows that titanium-tantalum alloy 90 is a potential material that can be used to replace existing commercially used cpTi and Ti6Al4V implant materials.

Notably, pure titanium has a hexagonal close packed (HCP) structure, i.e., an a phase, at ambient temperature. At temperatures greater than 883° C., pure titanium exists as a body centered cubic structure (BCC), i.e., a β phase. The β phase becomes stable at temperatures lower than 883° C. when β stabilizers are added and can be maintained in the metastable state at ambient temperature. Stability of the BCC structure depends on the extent of alloying elements. The amount of β stabilizer required to retain a purely β phase at ambient temperature depends on the Molybdenum Equivalency [3], an empirical rule derived from analysis of binary titanium alloys. In general, approximately 10 wt % of molybdenum is required to stabilize the β phase during quenching [4]. Molybdenum Equivalence is given by equation (1) below:

Mo_{eq}=1.0Mo+0.67V+0.44W+0.28Nb+0.22Ta+1.6Cr+ . . . −1.0Al (1)

Using the Mo_{eq}, the phase of different compositions of titanium-tantalum alloys formed by selective laser melting can be predicted. This is because during SLM, the parts undergo rapid cooling which is similar to rapid quenching, and the addition of tantalum in the TiTa alloy suppresses transformation of β phase to the α phase due to the β stabilizing effect. This was achieved by decreasing the critical cooling rate to retain the β phase and lowering of the martensitic start temperature. Coupled with the rapid solidification during SLM, TiTa produced by SLM exhibits a single β phase microstructure, and not α+β phase, despite being metastable.

Previous studies have also shown the preference of formation and growth of β phase over a phase at large undercooling. Metastable β titanium alloys are advantageous as their mechanical properties can be tailored. This implies that the SLM produced TiTa parts can be heat-treated to obtain various combinations of mechanical properties for different applications.

The energy density needed to form the TiTa alloys by SLM can also be predicted using the energy needed to reach the melting point of the different compositions of the alloys by rule of mixture. The empirical results are tabulated in Table 4 below.

TABLE 4

| | | | | | | Predicted |
|---|---|---|---|---|---|---|
| | | | | Energy | | energy |
| Ti | Ta | | Predicted | needed | Density | density |
| (wt %) | (wt %) | Mo_{eq} | phase | (kJ/kg) | (kg/cm³) | (J/cm³) |
| 100 | 0 | 0 | α | 848.74 | 4.51 | 3.83 |
| 90 | 10 | 2.2 | α + β | 805.52 | 4.87 | 3.92 |
| 70 | 30 | 6.6 | β | 719.10 | 5.77 | 4.15 |
| 50 | 50 | 11 | β | 632.67 | 7.10 | 4.49 |
| 30 | 70 | 15.4 | β | 546.24 | 9.22 | 5.04 |
| 10 | 90 | 19.8 | β | 459.82 | 13.14 | 6.04 |
| 0 | 100 | — | — | 416.60 | 16.69 | 6.95 |

When predicting phase difference and energy density, the specific heat capacity of titanium and tantalum are taken as 0.5223 kJ/kg·K and 0.1391 kJ/kg·K respectively. The melting points of titanium and tantalum are taken as 1650° C. and 3020° C. respectively. The titanium and tantalum powders are assumed to be at room temperature of 25° C. before SLM.

As SLM is a complex metallurgy process, there are many factors affecting the actual energy density range to form the alloy. In order to account for the actual SLM process, the experimental energy density range of 96 J/mm³ to at least 1400 J/mm³ for the titanium-tantalum alloy with 50 wt % of tantalum is used to predict the energy density range of the different compositions of titanium-tantalum alloys. The results are tabulated in Table 5 below.

TABLE 5

| | | Predicted experimental |
|---|---|---|
| Ti (wt %) | Ta (wt %) | energy density range (J/mm³) |
| 100 | 0 | 82-1194 |
| 90 | 10 | 84-1222 |
| 70 | 30 | 90-1314 |
| 50 | 50 | 96-1400 |
| 30 | 70 | 108-1571 |
| 10 | 90 | 129-1883 |
| 0 | 100 | 149-2167 |

The presently disclosed method enables the formation of titanium-tantalum alloys 90 as a substitute for Ti6Al4V because of its advantageously lower Young's modulus and comparable strength. In addition, the presently disclosed method provides a process for fabricating a TiTa 90 product directly, without the need for additional processing steps. One possible application of the abovementioned process is the fabrication of dental and orthopedic implants. With the versatility of tuning the TiTa powder ratio and the selective laser melting process, it is envisioned that the process (100) can be applied to the fabrication of TiTa 90 products for many other applications.

Whilst there has been described in the foregoing description exemplary embodiments of the present invention, it will be understood by those skilled in the technology concerned that many variations and combination in details of design, construction and/or operation may be made without departing from the present invention. For example, while the description above has mainly been with reference to selective laser melting (SLM), other powder bed fusion processes such as selective laser sintering (SLS) may alternatively be used in place of SLM.

### REFERENCES

[1] Zhou, Y.-L., et al., Comparison of Various Properties between Titanium-Tantalum Alloy and Pure Titanium for Biomedical Applications. Materials Transactions, 2007. 48(3): p. 380-384.
[2] Zhou, Y. L., M. Niinomi, and T. Akahori, Effects of Ta content on Young's modulus and tensile properties of binary TiTa alloys for biomedical applications. Materials Science and Engineering A, 2004. 371: p. 283-290.
[3] B. Vrancken, L. Thijs, J.-P. Kruth. J. Van Humbeeck, Microstructure and mechanical properties of a novel β titanium metallic composite by selective laser melting, Acta Materialia. 68 (2014) 150-158.
[4] D. Doraiswamy. S. Ankem, The effect of grain size and stability on ambient temperature tensile and creep deformation in metastable beta titanium alloys, Acta Materialia. 51 (2003) 1607-1619.

1. A titanium-tantalum alloy having a titanium wt % ranging from 10% to 70% and wherein the titanium has a body centered cubic structure.

2. The titanium-tantalum alloy of claim 1, wherein weight ratio of titanium to tantalum is 1:1.

3. The titanium-tantalum alloy of claim 2, wherein the titanium-tantalum alloy has a Young's modulus of less than 80 GPa and ultimate tensile strength greater than 900 MPa.

4. The titanium-tantalum alloy of claim 1, wherein the titanium-tantalum alloy is homogenous, having domains of titanium and tantalum each at most 1 mm long.

5. A method of forming a titanium-tantalum alloy, the method comprising the steps of:
(a) slicing a 3D CAD model of a part to be formed into a plurality of 2D image layers;
(b) preparing a homogenous powder mixture of titanium powder and tantalum powder;
(c) dispensing a layer of the powder mixture onto a processing bed;
(d) performing powder bed fusion of the layer of the powder mixture according to one of the 2D image layers in one of: a vacuum environment and an inert gas environment; and
(e) performing steps (c) and (d) for each of the plurality of 2D image layers in succession.

6. The method of claim 5, wherein weight ratio of titanium powder to tantalum powder in the powder mixture is 1:1.

7. The method of claim 5, wherein particle size of the titanium powder ranges from 5 μm to 40 μm.

8. The method of claim 5, wherein average particle size of the tantalum powder is at most 44 μm.

9. The method of claim 6, wherein performing powder bed fusion comprises selective laser melting and the energy density during the selective laser melting ranges from 96 J/mm³ to at least 1400 J/mm³.
